(19) United States
(12) Patent Application Publication
(10) Pub. No.: US 2018/0076662 A1
(43) Pub. Date: Mar. 15, 2018

(54) MANAGING INTERNET OF THINGS (IoT) DEVICES BASED ON ELECTRICAL POWER RELIABILITY

(71) Applicant: QUALCOMM Incorporated, San Diego, CA (US)

(72) Inventors: Ankit Maheshwari, Hyderabad (IN); Akash Kumar, Hyderabad (IN); Atul Soni, Hyderabad (IN)

(21) Appl. No.: 15/266,780

(22) Filed: Sep. 15, 2016

(51) Int. Cl. H02J 13/00; H02J 3/00; G05F 1/66; H04L 12/28

(52) U.S. Cl. CPC H02J 13/0013; H02J 3/00; G05B 2219/24139; H04L 12/2803; H02J 2003/007; G05F 1/66

(57) ABSTRACT

This disclosure provides systems, methods and apparatus, and computer programs encoded on computer storage media, for managing Internet of Things (IoT) devices. In one aspect, a processor of a smart meter device may determine a predicted reliability of electrical power. In some implementations, the processor may detect a predicted reliability of restored electrical power following a power outage. The processor may send an indication of the predicted reliability of the electrical power to an IoT device to enable the IoT device to perform an action based on the predicted reliability of the electrical power.

### TECHNICAL FIELD

This disclosure relates to managing Internet of Things (IoT) devices based on electrical power reliability.

### DESCRIPTION OF THE RELATED TECHNOLOGY

Computing devices that include wireless communication capabilities are becoming smaller, cheaper, and increasingly ubiquitous. Such computing devices are being incorporated with more and more objects, gradually creating a massively distributed network of computing devices generally referred to as the Internet of Things (IoT).

A “smart home” may include a wide variety of IoT devices, including lighting, security, entertainment, HVAC, and other systems and devices. IoT devices also may include devices that enable access to one or more communication systems, such as a cable communication network (such as a set top box or modem), the Internet (such as a wired or wireless router), and other such devices.

Residential and business power outages are a common problem around the world, particularly in developing countries. Power outages may have a variety of causes, including faults a power stations, damage to the power grid (such as transmission lines, substations, or other transmission infrastructure elements), and overload of electricity mains, or even intentional power reduction or shut down by antisocial elements. In some cases, a backup power supply may not be available. In addition to rendering many devices unusable, sudden power failures or reductions may damage equipment. Further, after electrical power is restored its reliability may vary. A fluctuating electrical power supply may cause devices and appliances to be repeatedly cycled on and off, which is undesirable for many such devices and appliances.

### SUMMARY

The systems, methods and devices of this disclosure each have several innovative aspects, no single one of which is solely responsible for the desirable attributes disclosed herein.

One innovative aspect of the subject matter described in this disclosure may be implemented in a smart meter device. In some implementations, the smart meter device may include an electrical coupling, a communication interface, and a processor coupled to the electrical coupling and the transceiver and configured with processor-executable instructions to perform operations including determining a predicted reliability of electrical power, and sending an indication of the predicted reliability of the electrical power to an Internet of Things (IoT) device to enable the IoT device to perform an action based on the predicted reliability of the electrical power.

In some implementations, the processor may be configured to perform operations such that determining the predicted reliability of electrical power may include detecting a restoration of electrical power following a power outage, and determining the predicted reliability of electrical power in response to detecting restoration electrical power following a power outage. In some implementations, the processor may be configured to perform operations such that determining the predicted reliability of the electrical power may include monitoring the electrical power to detect a change in voltage or frequency of the electrical power, wherein determining the predicted reliability of the electrical power may include determining the predicted reliability of the electrical power based upon detected changes in voltage or frequency of the electrical power.

In some implementations, the processor may be configured to perform operations further include determining a priority order for restoring power to two or more IoT devices, in which the priority order may be based on one or more of a power rating of each IoT device and a duration of the power outage. In some implementations, the processor may be configured to perform operations such that determining the predicted reliability of the electrical power may include determining whether a fluctuation of the electrical power over time meets a fluctuation threshold.

In some implementations, the processor may be configured to perform operations such that determining the predicted reliability of the electrical power may include determining that a future power failure may occur. In some implementations, the processor may be configured to perform operations such that determining the predicted reliability of the electrical power may include determining that a restored power after a power outage is unstable. In some implementations, the processor may be configured to perform operations such that determining the predicted reliability of the electrical power may be based on information related to a previous power outage.

In some implementations, the processor may be configured to perform operations such that determining the reliability of the electrical power may include analyzing fluctuations in the electrical power observed over time, and determining the predicted reliability of the electrical power based on the analysis of fluctuations in the electrical power observed over time. In such implementations, the processor may be configured to perform operations such that analyzing fluctuations in the electrical power observed over time may include determining one or more threshold values, and determining the predicted reliability of the electrical power based on the analysis of fluctuations in the electrical power observed over time may include comparing the determined one or more threshold values against fluctuation in one or more observed electrical power parameters.

Another innovative aspect of the subject matter described in this disclosure may be implemented in a method of managing Internet of Things (IoT) devices, which may include determining, by a smart meter device, a predicted reliability of electrical power, and sending an indication of the predicted reliability of the electrical power to an IoT device to enable the IoT device to perform an action based on the predicted reliability of the electrical power.

Another innovative aspect of the subject matter described in this disclosure may be implemented in a system for managing Internet of Things (IoT) devices, which may include a smart meter device that may include a communication interface and a processor coupled to the communication interface and configured with processor-executable instructions to perform operations that may include determining a predicted reliability of electrical power, and sending an indication of the predicted reliability of the electrical power to IoT devices. The system may further include an IoT device that may include a communication interface, and a processor coupled to the communication interface and configured with processor-executable instructions to perform operations that may include receiving the indication of the predicted reliability of the electrical power from the smart meter device, and performing an action based on the received indication of the predicted reliability of the electrical power.

Another innovative aspect of the subject matter described in this disclosure be implemented in a smart meter device, which may include means for determining a predicted reliability of electrical power, and means for sending an indication of the predicted reliability of the electrical power to an Internet of Things (IoT) device to enable the IoT device to perform an action based on the predicted reliability of the electrical power.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

The accompanying drawings, which are incorporated herein and constitute part of this specification, illustrate various implementations, and together with the general description given above and the detailed description given below, serve to explain the features of various implementations.

FIG. 1 shows a system block diagram of an example communication environment.

FIG. 2 shows a component block diagram of an example smart meter device.

FIG. 3 shows a component block diagram of an example Internet of Things (IoT) device.

FIG. 4 shows a process flow diagram of an example method of managing IoT devices.

FIG. 5 shows another process flow diagram of an example method of managing IoT devices.

FIG. 6 shows another process flow diagram of an example method of managing IoT devices.

FIG. 7 shows another process flow diagram of an example method of managing IoT devices.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein may be applied in a multitude of different ways. The described implementations may be implemented in any device, system, or network that is capable of transmitting and receiving RF signals according to any of the Institute of Electrical and Electronics Engineers (IEEE) 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other signals that are used to communicate within a wireless, cellular or Internet of Things (IoT) network, such as a system utilizing 3G, 4G or 5G, or further implementations thereof, technology.

The term “IoT device” is used herein to refer to a wireless device that may use radio frequency (RF) communications to communicate with another device, for example, as a participant in a communication network, such as the IoT. Such communications may include communications with another wireless device, a base station (including a cellular communication network base station and an IoT base station), an access point (including an IoT access point), or other wireless devices.

The implementations described therein provide methods for managing IoT devices. A “smart meter” is an IoT device that is connected to or in communication with a building's electricity meter and which may detect a flow or consumption of electricity. A smart meter may provide advance reporting and control functions for a building's electrical usage, such as accurate electricity usage data, managing load levels, reducing energy theft, storing electricity usage data over a period of time, and sending electricity usage reports to a master controller. In some implementations, a smart meter device or similar device may be enabled to manage IoT devices based on a reliability of electrical power. The smart meter device may include sensors that detect electricity flow or quality, including power fluctuations and outages. The smart meter device also may determine a predicted reliability of a power supply based on information from the sensors. A smart meter device also may use wired or wireless (such as RF) communications to communicate with another device (or user), such as an IoT device. In some implementations, a smart meter device may be installed in a residence, business, or another location, and may monitor and measure electricity supply and usage.

In some implementations, the smart meter device may monitor electrical power supplied to a building, home, or another structure. In some other implementations, the smart meter device may analyze electrical power fluctuations over time. In some implementations, the smart meter device may store historical data of the electrical power fluctuations.

In some implementations, the smart meter device may detect a restoration of electrical power following a power outage, and may determine a predicted reliability of the restored electrical power. The smart meter device may determine the predicted reliability of the restored electrical power based on a variety of factors and criteria, as further described below. In some implementations, the predicted reliability of the restored electrical power may include whether there is likely to be a fluctuation of electrical current or power such as rippling or dipping of voltage, frequency or current. In some implementations, the predicted reliability of the restored electrical power may include a degree to which a fluctuation of electrical current or power may occur. In some implementations, the predicted reliability of the restored electrical power may be determined based upon whether one or more power fluctuations meet a fluctuation threshold. In some implementations, the predicted reliability of electrical power may be defined in terms of whether the electrical power is likely to exhibit fluctuations meeting a fluctuation threshold over a period of time. In some implementations, the fluctuation threshold may represent a quality metric of the electrical power.

In various implementations, the smart meter device may send an indication of the predicted reliability of the electrical power to an IoT device. Based on the predicted reliability of the electrical power, the IoT device may perform an action. In some implementations, the smart meter device may instruct the IoT device to perform an action. In some implementations, the IoT device may determine an action to perform based on the predicted reliability of the electrical power.

Particular implementations of the subject matter described in this disclosure can be implemented to realize one or more of the following potential advantages. Various implementations provide improvements in functioning of an electrical system as well as in the management and functioning of IoT devices. Various implementations may provide notice to IoT devices to enable such devices to mitigate effects of unreliable power following restoration of power after a power interruption or brownout. Various implementations also may provide notice to IoT devices of a predicted unreliable or fluctuating electrical power that may cause some IoT devices to be repeatedly cycled on and off, which may shorten the lifespan of an IoT device or damage electrical or electronic components.

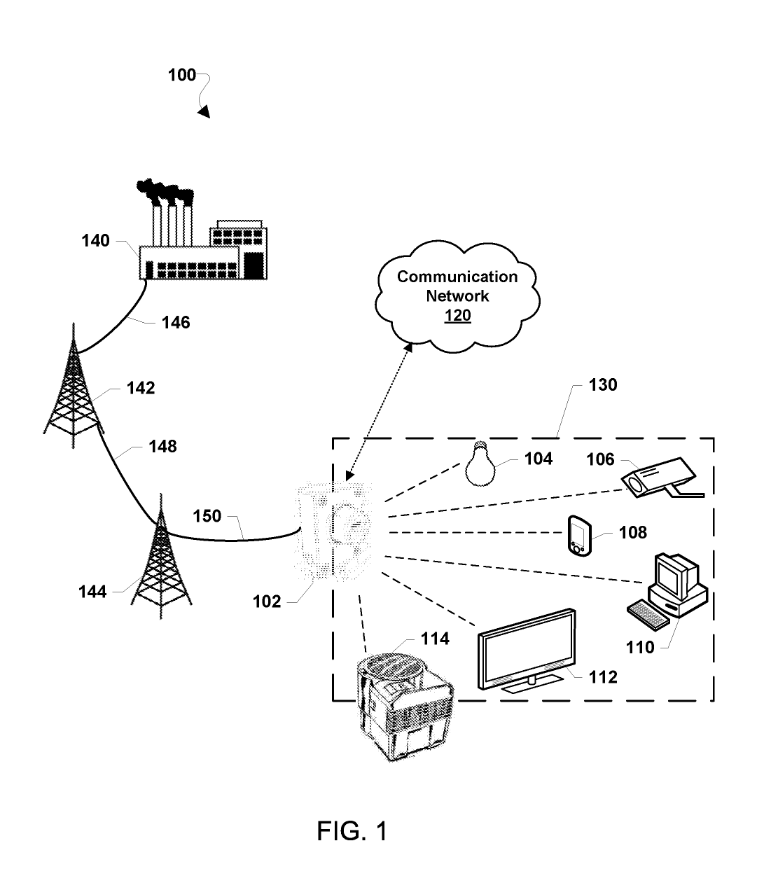

FIG. 1 shows a system block diagram of an example communication environment 100 in which various implementations may be used. The communication environment 100 may include a smart meter device 102 and a plurality of IoT devices 104-114. The smart meter device 102 and the plurality of IoT devices 104-114 may communicate with each other within an IoT network 130.

The smart meter device 102 and the plurality of IoT devices 104-114 may communicate by one or more wireless communication links (illustrated with dashed lines). The smart meter device 102 also may communicate with a communication network 120 by a wired or wireless communication link (illustrated with a dotted line).

Each of IoT devices 106-114 may communicate with the smart meter device 102 using radio frequency (RF) communications. Each of the IoT devices 104-114 may function to provide communications to a device such as, for example, an IoT lighting system 104, and IoT security system 106, a mobile communication device 108, a computing device 110, a smart television 112, and an HVAC (heating, ventilation, and air conditioning) system 114. The IoT network 130 may include other types of IoT devices without limitation.

The wireless communication links between the smart meter device 102 and the IoT devices 104-114 may include a plurality of carrier signals, frequencies, or frequency bands, each of which may include a plurality of logical channels. Each of the wireless communication links may utilize one or more radio access technologies (RATs). Examples of RATs that may be used in one or more of the various wireless communication links within the communication environment 100 include an Institute of Electrical and Electronics Engineers (IEEE) 802.15.4 protocol (such as Thread, ZigBee, and Z-Wave), 6LoWPAN, Bluetooth Low Energy (BLE), LTE Machine-Type Communication (LTE MTC), Narrow Band LTE (NB-LTE), Cellular IoT (CIoT), Narrow Band IoT (NB-IoT), BT Smart, Wi-Fi, LTE-U, LTE-Direct, MuLTEfire, as well as relatively extended-range wide area physical layer interfaces (PHYs) such as Random Phase Multiple Access (RPMA), Ultra Narrow Band (UNB), Low Power Long Range (LoRa), Low Power Long Range Wide Area Network (LoRaWAN), and Weightless.

Further examples of RATs that may be used in one or more of the various wireless communication links within the communication environment 100 include 3GPP Long Term Evolution (LTE), 3G, 4G, 5G, Global System for Mobility (GSM), Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs.

The IoT network 130 may be formed in or around a structure such as a home or business. The structure may receive electricity generated by a power plant 140 and transmitted via transmission towers 142 and 144 over transmission lines 146, 148, and 150.

The smart meter device 102 may measure the voltage, frequency, current or other measure of electricity supply quality that is delivered to the structure via the transmission line 150. For example, the smart meter device 102 may detect power outages and measure fluctuations in the power supply. The smart meter device 102 also may determine or predict a reliability of the supplied electrical power as described in more detail herein.

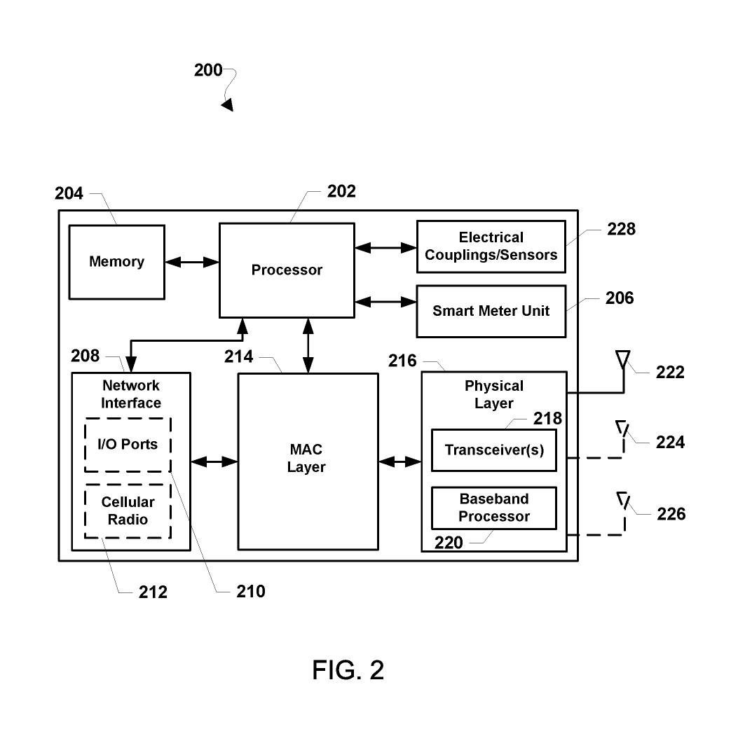

FIG. 2 shows a component block diagram of an example of a smart meter device 200 suitable for use with various implementations. With reference to FIGS. 1 and 2, in various implementations, the smart meter device 200 may be similar to the smart meter device 102.

The smart meter device 200 may include at least one controller, such as a processor 202. The processor 202 may be a processor configurable with processor-executable instructions to execute operations of the various implementations, a specialized processor, such as a modem processor, configurable with processor-executable instructions to execute operations of the various implementations in addition to a primary function, a dedicated hardware (i.e., “firmware”) circuit configured to perform operations of the various implementations, or a combination of dedicated hardware/firmware and a programmable processor.

The processor 202 may be coupled to memory 204, which may be a non-transitory computer-readable storage medium that stores processor-executable instructions. The memory 204 may store an operating system, as well as user application software and executable instructions. The memory 204 also may store application data, such as an array data structure. The memory 204 may include one or more caches, read only memory (ROM), random access memory (RAM), electrically erasable programmable ROM (EEPROM), static RAM (SRAM), dynamic RAM (DRAM), or other types of memory. The processor 202 may read and write information to and from the memory 204. The memory 204 also may store instructions associated with one or more protocol stacks. A protocol stack generally includes processor-executable instructions to enable communication using a radio access protocol or communication protocol.

The processor 202 also may be coupled to a smart meter unit 206. In various implementations, the smart meter unit 206 may be embodied in software, firmware, hardware, or some combination of software, firmware, and hardware. In some implementations, the smart meter unit 206 may be configured to monitor electrical power supply via one or more electrical couplings 228. The electrical couplings 228 may include physical couplings to connect to wires carrying electrical power, sensors configured to detect a flow of electricity, or another similar device.

The smart meter unit 206 may be configured to detect the presence or absence of the electrical power supply. The smart meter unit 206 may be configured to analyze electrical power fluctuations over time, and may store historical data of electrical power availability and fluctuations in the memory 204. The smart meter unit 206 may be further configured to determine a reliability of electrical power based on, among other things, measurements of the monitored electrical power supply and historical observations of the electrical power supply. The smart meter unit 206 may be configured to monitor electrical power to detect, for example, a change in voltage or frequency. The smart meter unit 206 also may be configured to send an indication of the determined reliability of the electrical power to one or more IoT devices (for example, the IoT devices 104-114). In some implementations, the smart meter unit 206 may be configured to determine a power rating for one or more IoT devices. In some implementations, the smart meter unit 206 may be configured to determine a priority order for providing restored electrical power to two or more IoT devices.

In some implementations, the smart meter device 200 may include a network interface 208 for connecting to a communication network (such as the communication network 120). The network interface 208 may include one or more input/output (I/O) ports 210 through which a connection to a network may be provided. For example, the I/O ports 210 may include an Ethernet connection, a fiber optic connection, a broadband cable connection, a telephone line connection, or other types of wired communication connections. Alternatively or in addition to the I/O ports 210, the network interface 208 may include a cellular radio unit 212 that provides a connection to a mobile telephony system or cellular data network through which access to the communication network may be acquired.

The processor 202 may be coupled to the Machine Access Control (MAC) layer 214. The MAC layer 214 may provide addressing and channel access control mechanisms between the network interface 208 and one or more devices associated with the smart meter device 200, such as IoT devices and wireless communication devices. The MAC layer 214 may be connected to a physical layer 216, which may perform various encoding, signaling, and data transmission and reception functions. The physical layer 216 may include one or more transceivers 218 and a baseband processor 220 for carrying out the various functions of the physical layer 216. The physical layer 216 may be coupled to one or more wireless antennas (such as wireless antennas 222, 224, and 226) to support wireless communications with devices associated with the smart meter device 200, such as wireless client devices or range extenders. Each of the transceivers 218 may be configured to provide communications using one or more frequency bands. The number of wireless antennas in the smart meter device 200 is not limited to three as illustrated in FIG. 2, but may include any number of antennas.

The smart meter device 200 also may include a bus for connecting the various components of the smart meter device 200 together, as well as hardware or software interfaces to enable communication among the various components. The smart meter device 200 also may include various other components not illustrated in FIG. 2. For example, the smart meter device 200 may include a number of input, output, and processing components such as buttons, lights, switches, antennas, display screen or touchscreen, various connection ports, additional processors or integrated circuits, and many other components.

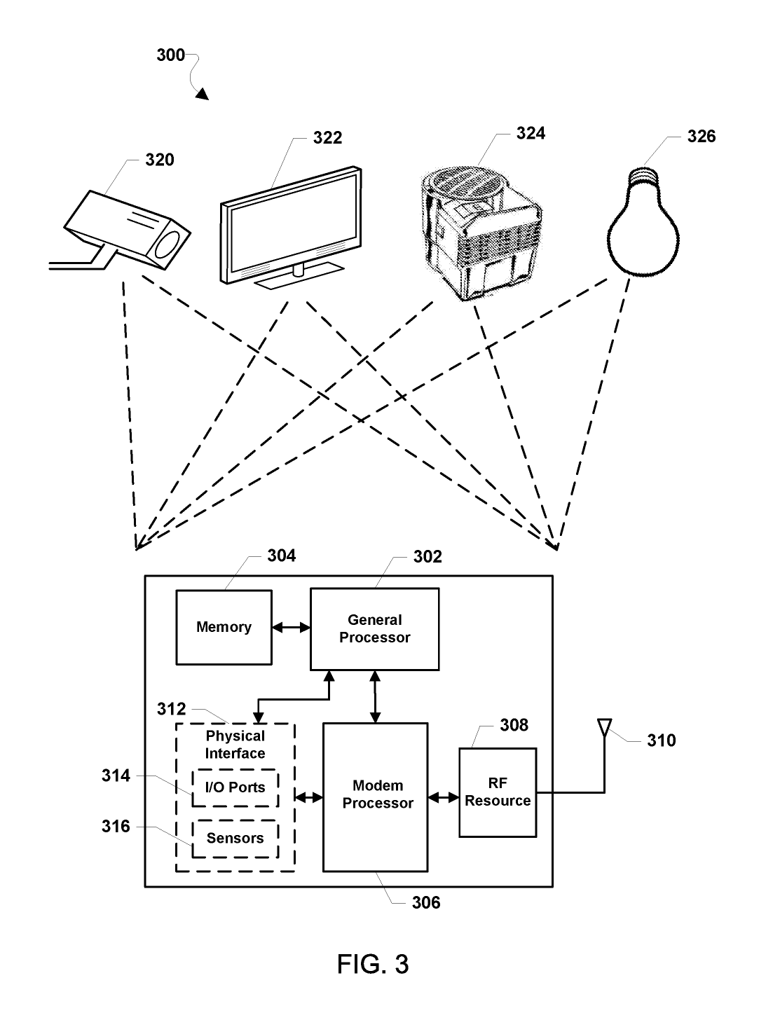

FIG. 3 shows a component block diagram of an example IoT device 300 suitable for implementing various implementations. In various implementations, the IoT device 300 may be similar to the IoT devices 104-114 shown in FIG. 1. IoT device 300 may be built into a variety of devices, including wireless access points supporting local wireless networks and smart appliances communicating with wireless networks. Non-limiting examples of smart appliances include televisions, set top boxes, kitchen appliances, lights and lighting systems, smart electricity meters, air conditioning/HVAC systems, thermostats, building security systems, doors and windows, door and window locks, and building diagnostic and monitoring systems. An IoT device 300 also may be in communication with, or coupled to, a system, device, or structure. Non-limiting examples of systems that may implement IoT device 300 include a security system 320, a smart television 322, an HVAC system 324, and in lighting system 326.

The processor 302 and the memory 304 may communicate with at least one modem processor 306. The modem processor 306 may perform modem functions for communications with one or more other IoT devices, access points, base stations, and other such devices. The modem processor 306 may be coupled to an RF resource 308. The RF resource 308 may include various circuitry and components to enable the sending, receiving, and processing of radio signals, such as a modulator/demodulator component, a power amplifier, a gain stage, a digital signal processor (DSP), a signal amplifier, a filter, and other such components. The RF resource 308 may be coupled to a wireless antenna (such as a wireless antenna 310). The IoT device 300 may include additional RF resources or antennas without limitation. The RF resource 308 may be configured to provide communications using one or more frequency bands via the antenna 310.

In some implementations, the processor 302 also may communicate with a physical interface 312 configured to enable a wired connection to another device. The physical interface 312 may include one or more input/output (I/O) ports 314 configured to enable communications with the device to which the IoT device is connected. The physical interface 312 also may include one or more sensors 316 to enable the IoT device to detect information about a device with which the IoT device 300 is connected via the physical interface 312. Examples of devices with which the IoT device may be connected include smart appliances including televisions, set top boxes, kitchen appliances, lights and lighting systems, smart electricity meters, air conditioning/HVAC systems, thermostats, building security systems, doors and windows, door and window locks, building diagnostic and monitoring systems, and other devices.

The IoT device 300 also may include a bus for connecting the various components of the IoT device 300 together, as well as hardware or software interfaces to enable communication among the various components. The IoT device 300 also may include various other components not illustrated in FIG. 3. For example, the IoT device 300 may include a number of input, output, and processing components, such as buttons, lights, switches, antennas, display screen or touchscreen, various connection ports, additional processors or integrated circuits, and many other components.

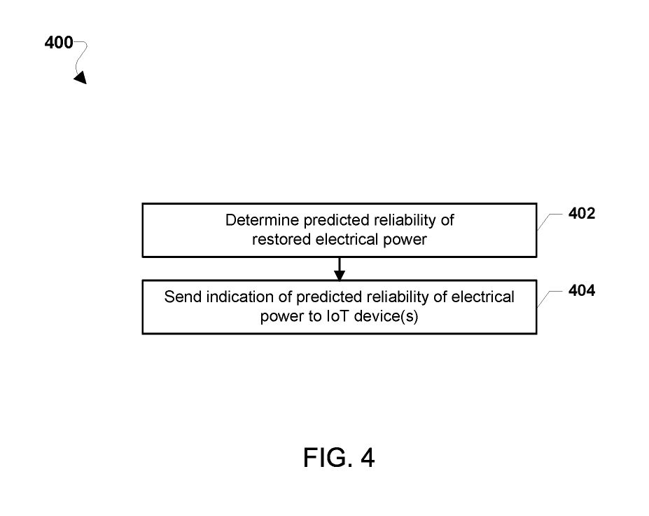

FIG. 4 shows a process flow diagram of an example method 400 of managing IoT devices according to some implementations. With reference to FIGS. 1-4, the method 400 may be implemented by a processor (such as the general processor 202 or another similar processor) of a smart meter device (such as the smart meter devices 102 and 200).

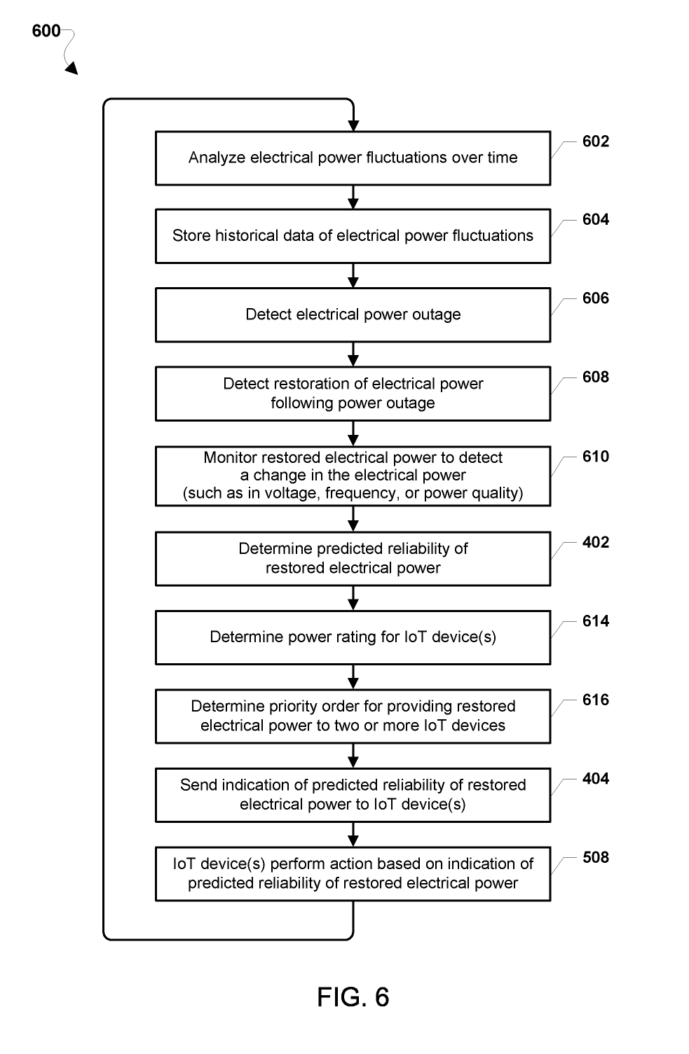

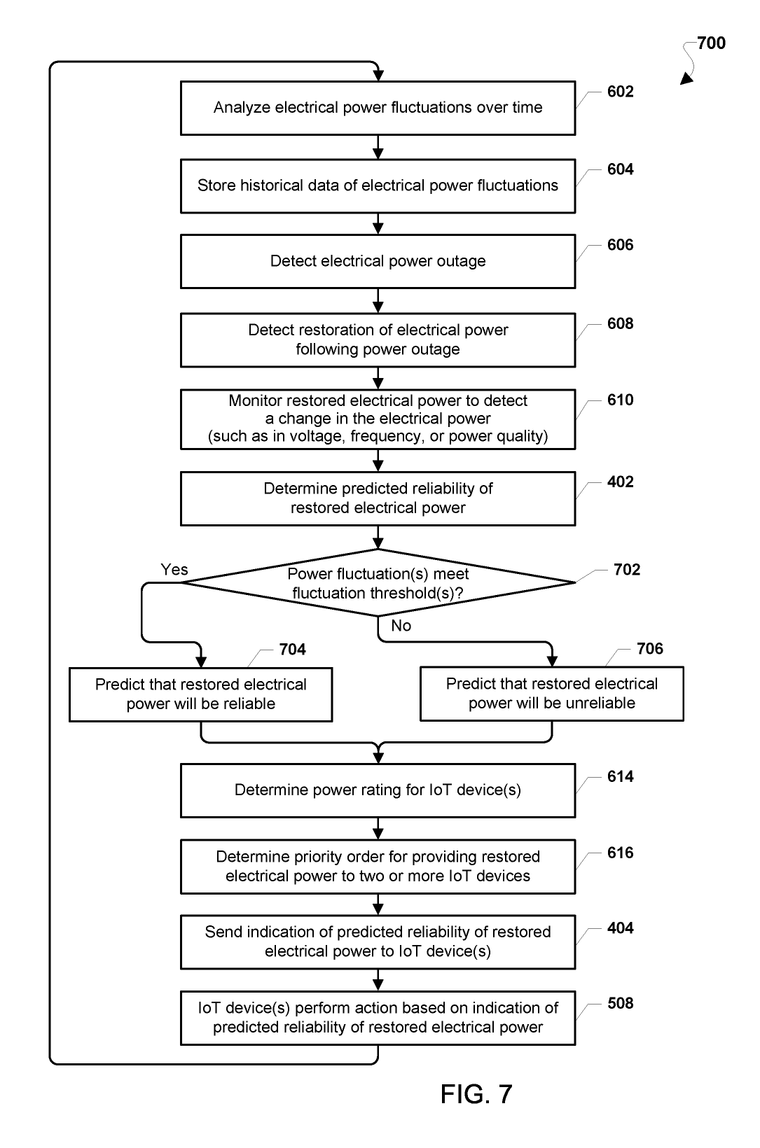

In block 402, a processor of a smart meter device (a “device processor”) may determine a predicted reliability of restored electrical power. Further details regarding information and methods used for determining the predicted reliability of restored electrical power are described with reference to FIGS. 6 and 7.

In block 404, the device processor may send an indication of the predicted reliability of restored electrical power to one or more IoT devices. Further details regarding the indications of predicted reliability of restored electrical power that may be sent to one or more IoT devices are described with reference to FIGS. 6 and 7.

The method 400 may be performed each time the smart meter device detects recovery from a power interruptions, such as a brownout or total loss of received electrical power.

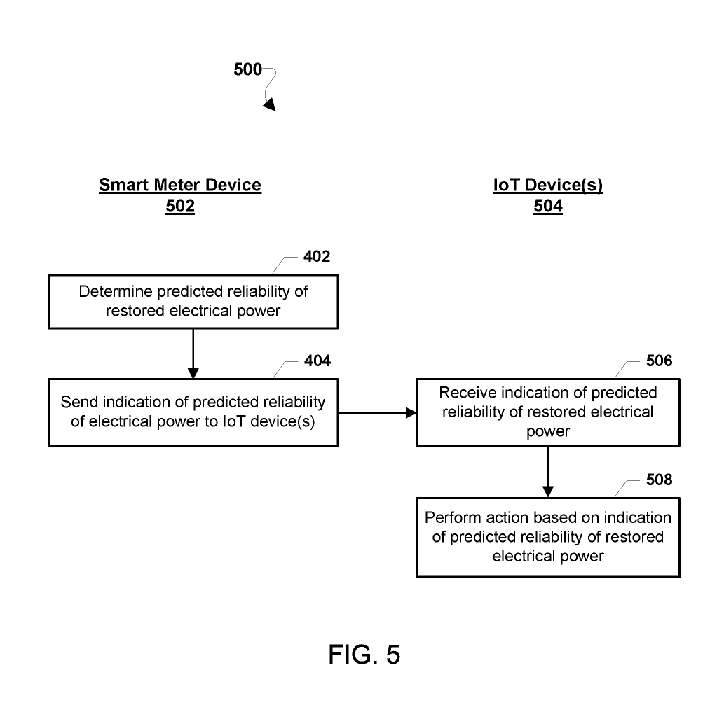

FIG. 5 shows a process flow diagram of an example method 500 of managing IoT devices based on monitored electrical power according to some implementations. With reference to FIGS. 1-5, the method 500 may be implemented by a processor (such as the general processor 202 or another similar processor) of a smart meter device 502 (such as the smart meter devices 102 and 200) and by a processor (such as the general processor 302 or another similar processor) of one or more IoT devices 504 (such as the IoT devices 104-114 and 300) (each a “device processor”). In blocks 402 and 404, the device processors may perform operations of the method 400 as described for like-numbered blocks with reference to FIG. 4.

In block 506, the device processor of the IoT device 504 may receive the indication of the predicted reliability of restored electrical power from the smart meter device 502. In block 508, the device processor of the IoT device 504 may perform an action based on the received indication of the predicted reliability of the electrical power. Further details regarding the actions that may be taken by one or more IoT devices are described with reference to FIGS. 6 and 7.

FIG. 6 shows a process flow diagram of an example method 600 of managing IoT devices according to some implementations. With reference to FIGS. 1-6, the method 600 may be implemented by a processor (such as the general processor 202 or another similar processor) of a smart meter device (such as the smart meter devices 102 and 200) and by a processor (such as the general processor 302 or another similar processor) of one or more IoT devices (such as the IoT devices 104-114 and 300) (each a “device processor”).

In block 602, the device processor of the smart meter device may analyze electrical power fluctuations over time. For example, the device processor may monitor electrical power supplied to a building or other structure (for example, via the transmission line 150). The device processor also may analyze fluctuations of the electrical power over a period of time. In various implementations, the electrical power fluctuations may include variations in voltage, variations in frequency, a number and timing of blackouts (such as power failures), a number and timing of brownouts (such as power reductions that are not power failures), and other changes to the quality or reliability of the electrical power supply.

The device processor may analyze the electrical power fluctuations to determine a timing of electrical power fluctuations, a frequency of electrical power fluctuations (such as a number of electrical power fluctuations over a time period), and other conditions or factors that may occur or be detected before or during an electrical power fluctuation. The device processor also may analyze the electrical power fluctuations to determine a correlation between or among events. For example, the device processor may determine that a certain fluctuation in voltage or frequency typically precedes a brownout or blackout. The device processor also may determine, for example, that the electrical power supply typically includes one or more electrical power fluctuations following a brownout or blackout (such as fluctuations in power that is restored following a brownout or blackout).

The device processor also may determine that one or more electrical power fluctuations may occur more or less frequently during a particular time of day, or during a particular time of year. For example, the device processor may determine that one or more electrical power fluctuations may correlate with a particular time of day. Examples of such time-correlated electrical power fluctuations may include peak residential electrical use times, such as in the morning before typical working hours, or in the evening after typical working hours, and peak commercial electrical use times during typical working hours. Other examples of time-correlated electrical power fluctuations may include seasonal use of high electricity consuming devices, such as air conditioner use during the summer, or use of large-screen televisions during popular sporting or entertainment events. These examples are not intended as limitations, and other examples are possible.

In some implementations, the device processor may determine one or more power quality metrics of the electrical power supply over time. In some implementations, the power quality metric may be determined based on a sinusoidal waveform of a magnitude and a frequency of the restored electrical power. In some implementations, the power quality metric may be based on a number or magnitude of transient voltages or currents in the restored electrical power. In some implementations, the power quality metric may be based on a harmonic content in a waveform of the electrical power.

The device processor of the smart meter device may use the analyzed electrical power fluctuations and other conditions or factors to determine a predicted reliability of electrical power, as further described below.

In block 604, the device processor of the smart meter device may store historical data of electrical power supply fluctuations, blackouts, and other quality variations. For example, the device processor may store the historical data in the memory 204. The historical data may include the analyzed power fluctuations over time.

In block 606, the device processor of the smart meter device may detect electrical power outage. The term “electrical power outage” is used herein for conciseness, and may include power reductions (such as a brownout, or a sudden power reduction below a threshold power level) in addition to a power loss (such as a blackout).

In block 608, the device processor of the smart meter device may detect a restoration of electrical power following the power outage. The restoration of electrical power may include a resumption of a supply of electrical power that meets or exceeds a threshold power level. The restoration of electrical power may follow a power reduction as well as a power loss.

In block 610, the device processor of the smart meter device may monitor the restored electrical power to detect a change in the electrical power. For example, the device processor may monitor the restored electrical power to detect a change of voltage, or a change of frequency, or a change in power quality, or any combination thereof. The change in the electrical power also may include one or more other fluctuations in the restored electrical power.

In block 402, the device processor of the smart meter device may determine a predicted reliability of the restored electrical power. In various implementations, the device processor of the smart meter device may determine the predicted reliability of the restored electrical power based on a variety of factors and criteria. In some implementations, the predicted reliability of the restored electrical power may include a forward-looking determination of the reliability of the restored electrical power. In some implementations, the device processor may monitor the restored electrical power (such as via the electrical couplings 228), and the device processor may determine the predicted reliability of the restored electrical power based on one or more aspects of the restored electrical power. In some implementations, the predicted reliability of the restored electrical power may be based on the stored historical data of observed electrical power fluctuations.

In some implementations, the predicted reliability of the restored electrical power may include a probability or likelihood that a fluctuation of electrical current or power will occur, such as rippling or dipping of voltage, frequency or current. In some implementations, the predicted reliability of the restored electrical power may include a degree to which a fluctuation of electrical current or power may occur. In some implementations, the predicted reliability of the restored electrical power may be determined based upon whether one or more predicted power fluctuations meet a fluctuation threshold. In some implementations, the predicted reliability of electrical power may be defined in terms of whether the electrical power is likely to exhibit fluctuations meeting a fluctuation threshold over a period of time. In some implementations, the fluctuation threshold may represent a quality metric of the electrical power.

In some implementations, the predicted reliability of the restored electrical power may include a predicted stability or degree of fluctuation of the restored electrical power. In some implementations, the device processor may determine whether an anticipated fluctuation of the restored electrical power over a period of time meets a threshold fluctuation level. For example, the device processor may determine that a fluctuation is likely to be at or below, or is at or below, a threshold fluctuation level. In some implementations, in response to determining that the anticipated fluctuation of the restored electrical power meets the threshold fluctuation level, the device processor may determine that the restored electrical power is reliable.

In some implementations, the predicted reliability of the restored electrical power may include a predicted power quality of the restored electrical power meeting a quality metric. In some implementations, the power quality metric may be determined based on a sinusoidal waveform of a magnitude and a frequency of the restored electrical power. For example, the device processor may determine whether a waveform of the restored electrical power is within (or matches) a threshold variance from a sinusoidal waveform. In such implementations, in response to determining that the waveform of the restored electrical power matches or is within the threshold variance from the sinusoidal waveform, the device processor may determine that the restored electrical power is reliable.

In some implementations, the power quality metric may be based on a number or magnitude of transient voltages or currents in the restored electrical power. For example, the device processor may determine whether the number or magnitude of transient voltages or currents in the restored electrical power is at or below a threshold number of transients or a threshold magnitude of voltages or currents. In such implementations, in response to determining that the number or magnitude of transient voltages or currents is at or below the threshold number of transients or the threshold magnitude, the device processor may determine that the restored electrical power is reliable.

In some implementations, the power quality metric may be based on a harmonic content in a waveform of the electrical power. For example, the device processor may determine whether the harmonic content of the waveform of the electrical power is at or below a threshold harmonic content level. In such implementations, in response to determining that the harmonic content of the waveform of the electrical power is at or below the threshold harmonic content level, the device processor may determine that the restored electrical power is reliable.

In some implementations, the device processor also may determine a level or a degree of predicted reliability. For example, the device processor may compare a fluctuation or a variance in the restored electrical power to two or more fluctuation thresholds, and may determine a level or a degree of predicted reliability based on the comparison to two or more thresholds. In some implementations, the device processor may determine a predicted variance from, or closeness to, a fluctuation threshold, and may determine a degree of predicted reliability based on the determined variance from or closeness to the fluctuation threshold.

In some implementations, the various threshold values used by the smart meter device to predict the reliability of the restored electrical power may be determined by the smart meter device based on observations of the power supply over time. For example, the smart meter device may correlate subsequent power failures (e.g., blackouts or brownouts) to various measurable parameters (e.g., voltage, frequency, current, fluctuations, etc.) in the power supply following a restoration of power. In some implementations, the threshold values may be determined by the smart meter device based on observations of the power supply over time using machine learning techniques to identify patterns in power reliability related to observable transients in voltage or current.

The foregoing examples are not intended as limitations, and the device processor may determine the reliability of the restored electrical power using other methods or techniques, including any or all of the above, as well as combinations thereof.

In block 614, the device processor of the smart meter device may determine a power rating for one or more IoT devices. For example, the device processor may determine a power rating for one or more of the IoT devices 104-114. The power rating may include, for example, a power level requirement that enables an IoT device to function in its intended manner without significant loss of performance or functionality. The power rating also may include a maximum level of fluctuation that enables the IoT device to function properly (that is, without significant loss of performance or functionality). The power rating also may include a minimum level of electric power quality (such as may be represented by the quality metric) that enables the IoT device to function properly.

In block 616, the device processor of the smart meter device may determine a priority order for providing the restored electrical power to two or more IoT devices. In some implementations, the priority order may be based on the predicted reliability of the restored electrical power. In some implementations, the priority order may be based on the predicted reliability of the restored electrical power and the determined power rating for the one or more IoT devices. For example, in response to determining that the restored electrical power is reliable, the device processor may prioritize systems related to environmental conditions or security conditions, such as the HVAC system 114 or the security system 106. As another example, in response to determining that the restored electrical power is unreliable, the device processor may decrease a priority of an IoT device that may be sensitive to electrical fluctuations, such as the computing device 110 or the smart television 112.

In some implementations, the device processor may set up a schedule for powering up one or more IoT devices in block 616, particularly devices having sensitive electronics. In some implementations, the device processor may schedule and send a power up message some period of time after main power has been restored. In some implementations, the schedule for powering up one or more IoT devices may include an instruction to the IoT devices to initiate power up some period of time after main power has been restored.

In some implementations, the device processor may determine the priority order in block 616 based on a level or a degree of reliability of the electrical power supply. For example, in response to determining that the degree of reliability of the restored electrical power is relatively low, the device processor may decrease the priority of sensitive electronic devices, or the device processor may increase the priority of relatively electrical fluctuation-insensitive devices.

In some implementations, the device processor may detect the presence of a backup power supply (such as an inverter or another indication of a backup power supply). In such implications, the device processor may determine the priority order in block 616 based on the determined power rating for the one or more IoT devices such that the determined priority order reduces a usage of the backup power supply. For example, the device processor may determine that the predicted reliability of the restored electrical power is highly unreliable. As another example, the device processor may determine that one or more IoT devices should use the backup power supply, for example, rather than reconnecting to the restored electrical power. In some implementations, the device processor may determine the priority order to “optimize” the usage of the backup power supply. In some implementations, the device processor may determine the priority order to increase over time the usage of the backup power supply. In some implementations, the device processor may determine the priority order based on the presence of the backup power supply, the determined power rating for the one or more IoT devices, and the predicted reliability of the restored electrical power.

In block 404, the device processor of the smart meter device may send an indication of the predicted reliability of restored electrical power to one or more IoT devices. In some implementations, the indication of predicted electrical power reliability also may include an instruction to perform an action, as further described below. In some implementations, the indication of the predicted electrical power reliability may not include any instruction, in which case each IoT device may determine an appropriate action to perform based on the indication of predicted electrical power reliability. The device processor of the one or more IoT devices may receive the indication of predicted reliability of restored electrical power.

In block 508, the device processor of the one or more IoT devices may perform an action based on the indication of predicted reliability of restored electrical power. For example, in cases where the indication of the predicted reliability of restored electrical power also includes an instruction to perform an action, an IoT device may perform the instructed action. As another example, an IoT device may use the indication of the predicted reliability of restored electrical power to determine an action to perform. Actions that may be performed by an IoT device (either at the instruction of the smart meter device or at the determination of the IoT device) may include restarting or reconnecting with the restored electrical power, delaying a restart or reconnection with the restored electrical power, avoiding or blocking a restart or reconnection with the restored electrical power, relying on battery power, and entering a low-power mode (for example, to enter a battery-only or sleep mode).

Some actions may be specific to the functions of the IoT device. For example, a smartphone may enter a call forwarding mode in which calls received by the smartphone are forwarded to another device (such as a wearable device, a computing device, or another similar device). As another example, the smartphone may send a message to a cellular network to enable call forwarding within the network (for example, at a base station, or at a call controller network element). As another example, a smartphone that is charging may determine to enter a low-power sleep mode (rather than continuing to charge) based on an indication that the predicted reliability of the restored electrical power is relatively low.

As another example, an IoT device that is sensitive to power fluctuations (such as the computing device 110 or the smart television 112) may cycle off or may delay restarting for a period of time based on the indication of the predicted reliability of the restored electrical power to, for example, prevent damage from a power surge or power fluctuation. In some implementations, the IoT device may determine an action to perform based on the determined level or degree of reliability of the restored electrical power (such as whether the restored electrical power is relatively reliable or relatively unreliable, based on a comparison to two or more thresholds).

The method 600 may be performed continuously by the device processor of the smart meter device by continuously monitoring and analyzing electrical power fluctuations over time in block 602. Thus, while the smart meter device processor predicts reliability of restored power and communicates with IoT devices, the device processor also may note the actual reliability of the restored power that is measure, and may use such differences between predicted and observed reliability to update prediction models, thresholds, etc.

FIG. 7 shows a process flow diagram of an example method 700 of managing IoT devices according to various implementations. With reference to FIGS. 1-7, the method 700 may be implemented by a processor (such as the general processor 202 or another similar processor) of a smart meter device (such as the smart meter devices 102 and 200) and by a processor (such as the general processor 302 or another similar processor) of one or more IoT devices (such as the IoT devices 104-114 and 300) (each a “device processor”). In blocks 402, 404, 508, and 602-616, the device processors may perform operations of like-numbered blocks of the methods 400, 500, and 600 as described with reference to FIGS. 4-6.

In determination block 702, the device processor of the smart meter device may determine whether one or more power fluctuations meet one or more power fluctuation thresholds. For example, the device processor may determine whether a fluctuation of the restored electrical power over a period of time meets a threshold fluctuation level. For example, the device processor may determine that the fluctuation is below, or is at or below, the threshold fluctuation level. As another example, the device processor may determine whether a waveform of the restored electrical power is within (or matches) a threshold variance from a sinusoidal waveform. As another example, the device processor may determine whether a number or magnitude of transient voltages or currents in the restored electrical power is at or below a threshold number of transients or a threshold magnitude of voltages or currents. As another example, the device processor may determine whether the harmonic content of the waveform of the electrical power is at or below a threshold harmonic content level. Other examples are also possible, as well as combinations of the foregoing. As described above, the various thresholds may be developed by the device processor from observing electrical power supply fluctuations over time in block 602.

In response to determining that the one or more power fluctuations meets the one or more power fluctuation thresholds (i.e., determination block 502=“Yes”), the device processor of the smart meter device may predict that the electrical power will be reliable in block 704.

In response to determining that the one or more power fluctuations does not meet the one or more power fluctuation thresholds (i.e., determination block 502=“No”), the device processor of the smart meter device may predict that electrical power will be unreliable in block 706.

In some implementations, based on the determination that the power will be reliable or unreliable, the device processor may determine the priority order for providing the restored electrical power to the two or more IoT devices in block 616. In some implementations, based on the prediction that the power is reliable (or unreliable), the device processor may determine an instruction to send to one or more IoT devices with the indication of the determined reliability of the restored electrical power in block 404. In some implementations, based on the prediction that the power is reliable (or unreliable), one or more of the IoT devices may determine an action to perform based on the predicted reliability of the restored electrical power in block 508.

Thus, various implementations enable a smart meter device to manage IoT devices based on a reliability of electrical power. Various implementations provide improvements in functioning of an electrical system as well as in the management and functioning of IoT devices. Various implementations may mitigate the effects of an unreliable power supply on certain IoT devices, such as damage or loss of function. Various implementations also may mitigate the effects of an unreliable or fluctuating electrical power, which may cause certain IoT devices to be repeatedly cycled on and off, which may shorten the lifespan of an IoT device or damage electrical or electronic components.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

In one or more aspects, the functions described may be implemented by a processor, which may be coupled to a memory. The memory may be a non-transitory computer-readable storage medium that stores processor-executable instructions. The memory may store an operating system, user application software, or other executable instructions. The memory also may store application data, such as an array data structure. The processor may read and write information to and from the memory. The memory also may store instructions associated with one or more protocol stacks. A protocol stack generally includes computer executable instructions to enable communication using a radio access protocol or communication protocol.

The term “component” is intended to include a computer-related part, functionality or entity, such as, but not limited to, hardware, firmware, a combination of hardware and software, software, or software in execution, that is configured to perform particular operations or functions. For example, a component may be, but is not limited to, a process running on a processor, a processor, an object, an executable, a thread of execution, a program, or a computer. By way of illustration, both an application running on a computing device and the computing device may be referred to as a component. One or more components may reside within a process or thread of execution and a component may be localized on one processor or core or distributed between two or more processors or cores. In addition, these components may execute from various non-transitory computer readable media having various instructions or data structures stored thereon. Components may communicate by way of local or remote processes, function or procedure calls, electronic signals, data packets, memory read/writes, and other computer, processor, or process related communication methodologies.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A smart meter device, comprising:
an electrical coupling;
a communication interface; and
a processor coupled to the electrical coupling and the communication interface and configured with processor-executable instructions to perform operations comprising:
determining a predicted reliability of electrical power; and
sending an indication of the predicted reliability of the electrical power to an Internet of Things (IoT) device to enable the IoT device to perform an action based on the predicted reliability of the electrical power.

2. The smart meter device of claim 1, wherein the processor is configured with processor-executable instructions to perform operations such that determining the predicted reliability of electrical power comprises:
detecting a restoration of electrical power following a power outage; and
determining the predicted reliability of electrical power in response to detecting restoration electrical power following a power outage.

3. The smart meter device of claim 2, wherein the processor is configured with processor-executable instructions to perform operations such that determining the predicted reliability of the electrical power comprises determining whether a fluctuation of the electrical power over time meets a fluctuation threshold.

4. The smart meter device of claim 1, wherein the processor is configured with processor-executable instructions to perform operations such that determining the predicted reliability of the electrical power comprises monitoring the electrical power to detect a change in voltage or frequency of the electrical power, wherein determining the predicted reliability of the electrical power comprises determining the predicted reliability of the electrical power based upon detected changes in voltage or frequency of the electrical power.

5. The smart meter device of claim 1, wherein the processor is configured with processor-executable instructions to perform operations further comprising:
determining a priority order for restoring power to two or more IoT devices,
wherein the priority order is based on one or more of a power rating of each IoT device and a duration of the power outage.

6. The smart meter device of claim 1, wherein the processor is configured with processor-executable instructions to perform operations such that determining the predicted reliability of the electrical power comprises determining that a future power failure may occur.

7. The smart meter device of claim 1, wherein the processor is configured with processor-executable instructions to perform operations such that determining the predicted reliability of the electrical power comprises determining that a restored power after a power outage is unstable.

8. The smart meter device of claim 1, wherein the processor is configured with processor-executable instructions to perform operations such that determining the predicted reliability of the electrical power is based on information related to a previous power outage.

9. The smart meter device of claim 1, wherein the processor is configured with processor-executable instructions to perform operations such that determining the reliability of the electrical power comprises:
analyzing fluctuations in the electrical power observed over time; and
determining the predicted reliability of the electrical power based on the analysis of fluctuations in the electrical power observed over time.

10. The smart meter device of claim 9, wherein the processor is configured with processor-executable instructions to perform operations such that:
analyzing fluctuations in the electrical power observed over time comprises determining one or more threshold values; and
determining the predicted reliability of the electrical power based on the analysis of fluctuations in the electrical power observed over time comprises comparing the determined one or more threshold values against fluctuation in one or more observed electrical power parameters.

11. A method of managing Internet of Things (IoT) devices, comprising:
determining, by a smart meter device, a predicted reliability of electrical power; and
sending an indication of the predicted reliability of the electrical power to an IoT device to enable the IoT device to perform an action based on the predicted reliability of the electrical power.

12. The method of claim 11, wherein determining, by the smart meter device, the predicted reliability of electrical power comprises:
detecting, by the smart meter device, a restoration of electrical power following a power outage; and
determining, by the smart meter device, the predicted reliability of electrical power in response to detecting restoration electrical power following a power outage.

13. The method of claim 12, further comprising:
determining, by the smart meter device, a priority order for restoring power to two or more IoT devices,
wherein the priority order is based on one or more of a power rating of each IoT device and a duration of the power outage.

14. The method of claim 11, wherein determining the predicted reliability of the electrical power comprises monitoring the electrical power, by the smart meter device, to detect a change in voltage or frequency of the electrical power,
wherein determining the predicted reliability of the electrical power comprises determining the predicted reliability of the electrical power based upon detected changes in voltage or frequency of the electrical power.

15. The method of claim 11, wherein determining the predicted reliability of the electrical power comprises determining whether a fluctuation of the electrical power over time meets a fluctuation threshold.

16. The method of claim 11, wherein determining the predicted reliability of the electrical power comprises determining that a future power failure may occur.

17. The method of claim 11, wherein determining the predicted reliability of the electrical power comprises determining that a restored power after a power outage is unstable.

18. The method of claim 11, wherein determining the predicted reliability of the electrical power is based on information related to a previous power outage.

19. The method of claim 11, wherein determining the reliability of the electrical power comprises:
analyzing fluctuations in the electrical power observed over time; and
determining the predicted reliability of the electrical power based on the analysis of fluctuations in the electrical power observed over time.

20. The method of claim 19,
wherein analyzing fluctuations in the electrical power observed over time comprises determining one or more threshold values, and
wherein determining the predicted reliability of the electrical power based on the analysis of fluctuations in the electrical power observed over time comprises comparing the determined one or more threshold values against fluctuation in one or more observed electrical power parameters.

21. A system for managing Internet of Things (IoT) devices, comprising:
a smart meter device comprising:
a communication interface; and
a processor coupled to the communication interface and configured with processor-executable instructions to perform operations comprising:
determining a predicted reliability of electrical power;
sending an indication of the predicted reliability of the electrical power to IoT devices; and
an IoT device comprising:
a communication interface; and
a processor coupled to the communication interface and configured with processor-executable instructions to perform operations comprising:
receiving the indication of the predicted reliability of the electrical power from the smart meter device; and
performing an action based on the received indication of the predicted reliability of the electrical power.

22. The system of claim 21, wherein the processor of the IoT device is configured with processor-executable instructions to perform operations such that performing the action based on the received indication of the predicted reliability of the electrical power comprises performing one or more of powering down the IoT device, operating in a battery power mode, reconnecting to restored power, and determining a delay period after which the IoT device reconnects to the restored power.

23. A smart meter device, comprising:
means for determining a predicted reliability of electrical power; and
means for sending an indication of the predicted reliability of the electrical power to an Internet of Things (IoT) device to enable the IoT device to perform an action based on the predicted reliability of the electrical power.

24. The smart meter device of claim 23, wherein means for determining the predicted reliability of electrical power comprises:
means for detecting a restoration of electrical power following a power outage; and
means for determining the predicted reliability of electrical power in response to detecting restoration electrical power following a power outage.

25. The smart meter device of claim 24, further comprising:
means for determining a priority order for restoring power to two or more IoT devices,
wherein the priority order is based on one or more of a power rating of each IoT device and a duration of the power outage.

26. The smart meter device of claim 23,
wherein means for determining the predicted reliability of the electrical power comprises means for monitoring the electrical power to detect a change in voltage or frequency of the electrical power, and
wherein means for determining the predicted reliability of electrical power comprises means for determining the predicted reliability of the electrical power based upon detected changes in voltage or frequency of the electrical power.

27. The smart meter device of claim 23, wherein means for determining the predicted reliability of electrical power comprises means for determining whether a fluctuation of the electrical power over time meets a fluctuation threshold.

28. The smart meter device of claim 23, wherein means for determining the predicted reliability of electrical power comprises means for determining that a future power failure may occur.

29. The smart meter device of claim 23, wherein means for determining the predicted reliability of electrical power comprises means for determining that a restored power after a power outage is unstable.

30. The smart meter device of claim 23, wherein means for determining the predicted reliability of electrical power comprises means for determining the predicted reliability of the electrical power based on information related to a previous power outage.
